(19) United States
(12) Patent Application Publication
(10) Pub. No.: US 2009/0003161 A1
(43) Pub. Date: Jan. 1, 2009

(54) Method for Determining the Rotation Frequency of an Optical Recording Medium

(76) Inventor: Stefan Basler, Brigachtal (DE)

Correspondence Address: Joseph J. Laks;Thomson Licensing LLC, 2 Independence Way, Patent Operations, PO Box 5312, PRINCETON, NJ, 08543, US

(21) Appl. No.: 11/658,945

(22) PCT Filed: Jul. 15, 2005
(86) PCT No.: PCT/EP2005/053408

§ 371 Date: Jan. 29, 2007

(30) Foreign Application Priority Data
Jul. 30, 2004 (EP) 04018061.4
Jan. 20, 2005 (EP) 05100328.3

(51) Int. Cl. G11B 5/09

(52) U.S. Cl. 369/47.38

(57) ABSTRACT

The present invention relates to a method for determining the rotation frequency of an optical recording medium driven at a constant linear velocity, and to an apparatus for reading from and/or writing to optical recording media using this method. According to the invention, the method includes the steps of:
determining the number of tracks relative to a reference position on the optical recording medium based on the current subcode or sector information; and
calculating an approximate value for the rotation frequency from the determined number of tracks.

The present invention relates to a method for determining the rotation frequency of an optical recording medium, and to an apparatus for reading from and/or writing to optical recording media using this method.

For some operations within a drive for optical recording media a measure proportional to the rotation frequency of the optical recording medium is required. For example, some adjustments are ideally related to the rotation frequency of the optical recording medium. However, due to cost reduction requirements an encoder system for directly measuring the current rotation frequency of the optical recording medium is often omitted in drives for optical recording media driven at a constant linear velocity. In this case an alternative solution for determining the rotation frequency is needed.

It is an object of the invention to propose a method for determining the rotation frequency of an optical recording medium driven at a constant linear velocity if the rotation frequency cannot be directly measured.

According to the invention, this object is achieved by a method including the steps of:
determining the number of tracks relative to a reference position on the optical recording medium based on the current subcode or sector information; and
calculating an approximate value for the rotation frequency from the determined number of tracks.

For a specific optical recording medium driven at a specific constant linear velocity, the rotation period T is given by T=a+bN, where N is the number of tracks relative to the reference position and a and b are constants. From the rotation period T the rotation frequency f can be calculated using f=1/T. Preferably, the reference position on the optical recording medium is the beginning of a program area.

Favourably, the method further includes the steps of:
determining one or more operational parameters; and
using the determined operational parameters for calculating the approximate value for the rotation frequency.

If different linear velocities are available, the currently used velocity has to be taken into account. When in addition different types of optical recording media can be reproduced, the specific parameters of the current optical recording medium are needed. These parameters include the radius of the reference position and the distance between adjacent tracks. Using these values, the constants a and b can be calculated for different types of recording media and different linear velocities.

A method according to the invention is favourably used in an apparatus for reading from and/or writing to optical recording media for determining the rotation frequency of an optical recording medium driven at a constant linear velocity.

For a better understanding the invention shall now be explained in more detail in the following description with reference to the figures. It is understood that the invention is not limited to this exemplary embodiment and that specified features can also expediently be combined and/or modified without departing from the scope of the present invention. In the figures:

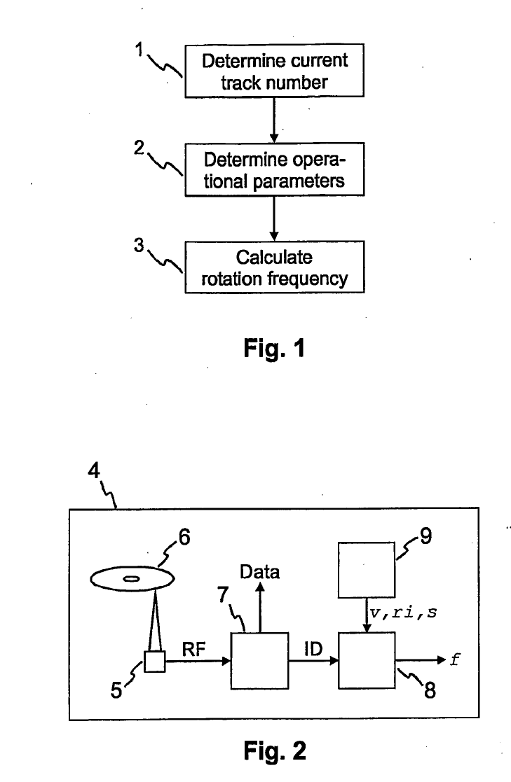

FIG. 1 depicts a method according to the invention for determining the rotation frequency of an optical recording medium, and

FIG. 2 schematically shows an apparatus for reading from and/or writing to optical recording media using a method according to the invention.

FIG. 1 depicts a method according to the invention for determining the rotation frequency of an optical recording medium. In a first step 1 the track number of the current position is calculated. This is done by applying algorithms commonly known for calculating the track number differences between a current track and a target track for track jump operations. In the present case, such an algorithm is applied to a notional track jump from the current position to the beginning of the program area of the optical recording medium. Basis for this step are the subcode or sector ID's on the optical recording medium. Of course, instead of the beginning of the program area any other reference position on the optical recording medium can be used. In the next step 2, a plurality of operational parameters are determined, e.g. the type of optical recording medium and the employed linear velocity. Of course, one or more of these parameters can likewise be determined beforehand. For example, the type of optical recording medium is usually determined before playback of the optical recording medium is initiated. The results of the first two steps form the basis of the third step 3, in which the current rotation frequency is calculated. In the following, the dependence between the rotation frequency and the values determined in the first step 1 and the second step 2 is described in terms of mathematical equations.

For a system operated at constant linear velocity (CLV) the relationship of circumference and linear velocity to disk rotation period is given by Equation 1, where T is the period of one rotation in

$$[ \frac{sec}{rot} ] ,$$

U is the circumference at the current location in [m], and v is the constant linear velocity

$$[ \frac{m}{sec} ] .$$

$$T = \frac{U}{v} \qquad Equation 1$$

Taking into account that U=2πr, r being the radius in [m], Equation 1 can be rewritten as:

$$T = \frac{2 π r}{v} \qquad Equation 2$$

Considering further that r=ri+N×s, where ri is the radius at the beginning of program area in [m], N is the number of tracks relative to the beginning of the program area in [tracks], and s is the track pitch in [m], i.e. the distance between two adjacent tracks, the radius of the current position can be expressed in terms of the radius of the beginning of the program area and the offset for the current position in terms of the track number and the track pitch.

$$T = \frac{2 π}{v} ( ri + N \times s ) \qquad Equation 3$$

This equation allows to calculate the rotation period T from the operational parameters and the current track.

Finally, the relationship between the period T and the frequency f in

$$[ \frac{rot}{sec} ]$$

is given by:

$$f = \frac{1}{T} \qquad Equation 4$$

In the following a Compact Disk (CD) is used as an example for an optical recording medium. Of course, the invention is likewise applicable to other optical recording media driven at constant linear velocity. For a CD driven at 1× speed the linear velocity according to the standard is 1.2-1.4 m/sec. An empirical mean value is

$$v = 1.25 [ \frac{m}{sec} ] .$$

Filling in the actual figures for a CD driven at 1× speed in equation 3, i.e.

$$v = 1.25 [ \frac{m}{sec} ] ,$$

ri=25×10⁻³ [m] and

$$s = 1.6 \times {10}^{- 6} [ \frac{m}{track} ] ,$$

yields:

$$T [ \frac{sec}{rot} ] = \frac{2 π}{1.25 [ \frac{m}{sec} ]} ( 25 \times {10}^{- 3} [ m ] + N \times 1.6 \times {10}^{- 6} [ \frac{m}{track} ] ) \qquad Equation 5$$

By replacing

$$1.6 \times {10}^{- 6} [ \frac{m}{track} ] = \frac{1}{625 [ \frac{tracks}{mm} ]}$$

in Equation 5 and rounding it to integer values, an approximate value ‘msec per rotation period’ is obtained. This result is appropriate in accuracy and dimension for most applications and efficient to compute on fixed point processors.

$$T [ \frac{msec}{rot} ] \approx 5 [ \frac{sec}{m} ] \times ( 25 [ mm ] + \frac{N [ tracks ]}{625 [ \frac{tracks}{mm} ]} ) \qquad Equation 6$$

For an apparatus which can only reproduce a single type of optical recording medium at a specific constant linear velocity, e.g. a CD player, the rotation period is given by a simple linear equation T=a+bN, with a and b being constants. If different constant linear velocities are available, the currently used velocity has to be taken into account. When in addition different types of optical recording media can be reproduced, the specific parameters of the current optical recording medium are needed. Consequently, in order to at least approximately determine the rotation frequency it is sufficient to calculate the current position on the recording medium relative to the centre or any other reference position of the recording medium, and to use this current position to calculate the rotation frequency based on the specific operating parameters like linear velocity etc. The invention is likewise applicable to zoned CLV media, i.e. media with different constant linear velocities for different zones of the medium.

FIG. 2 schematically shows an apparatus 4 for reading from and/or writing to optical recording media 6. The apparatus includes an optical pickup 5 for reading digital data RF from the optical recording medium 6. For simplicity, in the figure the processing of the analog signal read by the optical pickup 5 to obtain the digital data RF has been omitted. This processing is well known to a person skilled in the art. The data signal RF is transmitted to a processor 7, which extracts sector or subcode ID's and provides them to a rotation frequency determination means 8. The processor also extracts other data from the data signal RF and provides them to further processing means (not shown) of the apparatus. In addition to the sector or subcode ID's the rotation frequency determination means 8 also receives the necessary operational parameters v, ri and s from a parameter determination means 9. Based on the operational parameters and the sector or subcode ID's the rotation frequency determination means 8 calculates an approximate value for the rotation frequency f in accordance with the above derived equation 3.

1-6. (canceled)

7. Method for determining the rotation frequency of an optical recording medium driven with a constant linear velocity, including the step of:
approximating the rotation frequency from a current subcode or sector information.

8. Method according to claim 7, wherein the step of approximating the rotation frequency from a current subcode or sector information includes:
determining the number of tracks relative to a reference position on the optical recording medium based on the current subcode or sector information; and
calculating an approximate value for the rotation frequency from the determined number of tracks.

9. Method according to claim 8, further including the steps of:
determining one or more operational parameters; and
using the determined operational parameters for calculating the approximate value for the rotation frequency.

10. Method according to claim 8, wherein the operational parameters include the constant linear velocity, the radius of the reference position, and the distance between adjacent tracks.

11. Method according to claim 7, wherein the reference position on the optical recording medium is the beginning of a program area.

12. Apparatus for reading from and/or writing to optical recording media, wherein it is adapted to perform a method according to claim 7 for determining the rotation frequency of an optical recording medium driven at a constant linear velocity.
